(19) United States
(12) Patent Application Publication
(10) Pub. No.: US 2023/0142595 A1
(43) Pub. Date: May 11, 2023

(54) Aerosol Generation Device

(71) Applicant: JT International SA, Geneva (CH)

(72) Inventors: Andrew Robert John Rogan, Forres (GB); Alec Wright, Guildford (GB)

(73) Assignee: JT International SA, Geneva (CH)

(21) Appl. No.: 17/768,069

(22) PCT Filed: Oct. 7, 2020
(86) PCT No.: PCT/EP2020/078177

§ 371 Date: Apr. 11, 2022

(30) Foreign Application Priority Data
Oct. 9, 2019 (EP) 19202286.1

(51) Int. Cl. A24F 40/46; A24F 40/50

(52) U.S. Cl. CPC A24F 40/46; A24F 40/50

(57) ABSTRACT

An aerosol generation device generates an aerosol from a consumable. The consumable has a plurality of adjacent layers including a heater layer comprising electrically conductive material and a layer of aerosol substrate on each side of the heater layer and attached to the electrically conductive material. The aerosol generation device comprises a housing and a plurality of electrical contacts. The housing comprises a chamber adapted to hold the consumable. The plurality of electrical contacts are arranged to supply power to the heater layer of the consumable held in the chamber, through one or both outer layers of the plurality of adjacent layers of the consumable.

### TECHNICAL FIELD

The present disclosure relates to aerosol generation devices and consumables for aerosol generation devices. The consumable may comprise tobacco or other suitable aerosol substrate materials to be heated, rather than burned, to generate an aerosol for inhalation.

### BACKGROUND

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn device. Devices of this type generate an aerosol or vapour by heating an aerosol substrate that typically comprises moist leaf tobacco or other suitable aerosolisable material to a temperature typically in the range 150° C. to 350° C. Heating an aerosol substrate, but not combusting or burning it, releases an aerosol that comprises the components sought by the user but not the toxic and carcinogenic by-products of combustion and burning. Furthermore, the aerosol produced by heating the tobacco or other aerosolisable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

It is desirable to provide a consumable or aerosol generation device that can generate an aerosol with improved energy efficiency or with a reduced heat-up time.

### SUMMARY OF THE DISCLOSURE

In a first aspect of the present disclosure, there is provided an aerosol generation device for generating an aerosol from a consumable comprising a plurality of adjacent layers including a heater layer comprising electrically conductive material and a layer of aerosol substrate on each side of the heater layer and attached to the electrically conductive material. The device comprises a housing and a plurality of electrical contacts. The housing comprises a chamber adapted to hold the consumable. The plurality of electrical contacts are arranged to supply power to the heater layer of the consumable held in the chamber, through one or both outer layers of the plurality of adjacent layers of the consumable.

Optionally, the chamber is adapted such that, when the consumable is inserted, the consumable is positioned for the electrical contacts to supply power to the heater layer.

Optionally, the chamber comprises an opening through which the consumable can be inserted and removed, and the aerosol generation device further comprises a cover arranged to move between an open position in which the opening is open and a closed position in which the opening is closed.

Optionally, the cover is attached to the housing by a hinge.

Optionally, the device further comprises a piercing element including a piercing electrical contact of the plurality of electrical contacts of the aerosol generation device, the piercing element being adapted to pierce the consumable and form an electrical connection between the piercing electrical contact and the heater layer.

Optionally, the piercing element has a needle-type, crown-type, blade-type or punch-type tip.

Optionally, the piercing element includes multiple piercing electrical contacts of the plurality of electrical contacts of the aerosol generation device arranged to form multiple electrical connections with the heater layer.

Optionally, the cover is arranged to push the piercing element into the consumable as the cover moves to the closed position.

Optionally, the device further comprises an actuator arranged to drive the piercing element into the consumable.

Optionally, an electrical contact of the plurality of electrical contacts of the aerosol generation device is arranged to form an electrical connection with a respective electrical contact of the consumable connected in the consumable between the heater layer and an outer layer of the plurality of adjacent layers.

Optionally, the plurality of electrical contacts are arranged to extend within the chamber to supply power to the heater layer of the consumable held in the chamber, through one or both outer layers of the plurality of adjacent layers of the consumable. The plurality of electrical contacts may be arranged to extend in a direction transversal to the longitudinal direction of the chamber. The plurality of electrical contacts may extend at least along 30%, preferably at least 40%, most preferably at least 50% of the transversal dimension of the chamber. The plurality of electrical contacts may comprise at least two contacts longitudinally distanced along the longitudinal direction. The two contacts are at least distanced a distance of at least 50%, preferably at least 70%, most preferably at least 90% the length of the chamber in the longitudinal direction.

In a second aspect of the present disclosure, there is provided a system for generating an aerosol comprising an aerosol generation device as described previously and a consumable comprising a plurality of adjacent layers including a heater layer and a layer of aerosol substrate on each side of the heater layer.

Optionally, at least one layer of aerosol substrate of the consumable is arranged to be pierced by the piercing element of the aerosol generation device.

### BRIEF DESCRIPTION OF THE DRAWINGS

FIG. 1 schematically illustrates a cross-section of a consumable;

FIGS. 2A and 2B schematically illustrate cross-sections of an aerosol generation device according to the invention, without and with a consumable;

FIG. 3 schematically illustrates plan views of consumables;

FIGS. 4A and 4B schematically illustrate a cross-section of another, and a tool which may be associated with the another consumable;

FIG. 5 schematically illustrates a cross-section of another consumable;

FIG. 6 schematically illustrates different types of piercing element which may be used in an aerosol generation device according to the invention;

FIG. 7 schematically illustrates a cross-section of another consumable;

FIGS. 8A and 8B schematically illustrate cross-sections of another aerosol generation device according to the invention, without and with a consumable;

### DETAILED DESCRIPTION

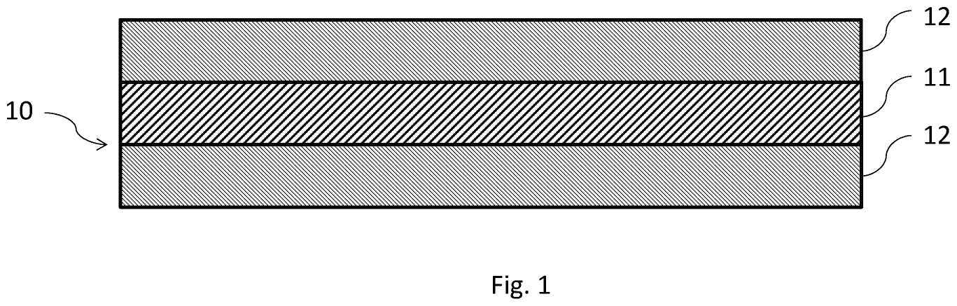

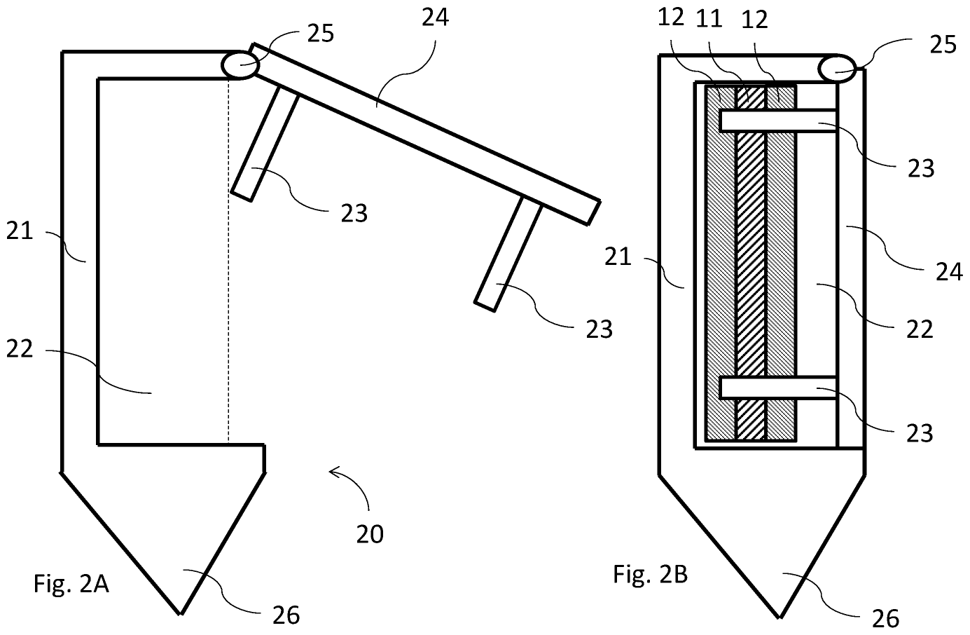

The present invention provides an aerosol generation device for a layered consumable, the basic principle of which can be understood by reference to FIGS. 1, 2A and 2B.

FIG. 1 schematically illustrates a cross-section of a consumable 10 comprising a plurality of adjacent layers. The adjacent layers comprise a heater layer 11 comprising electrically conductive material. The adjacent layers additionally comprise a layer of aerosol substrate 12 on each side of the heater layer 11 and attached to the heater layer 11.

FIG. 2A schematically illustrates a cross-section of an aerosol generation device 20 in which the consumable 10 may be received, while FIG. 2B schematically illustrates a cross-section of the aerosol generation device 20 containing the consumable 10. As shown in FIGS. 2A and 2B, the aerosol generation device comprises electrical contacts 23 which are arranged to supply power to the heater layer 11 of the consumable, through one or both outer layers of the plurality of adjacent layers of the consumable (in other words, through one or both of the first and last layers in the plurality of adjacent layers, which in this case are the aerosol substrate layers 12). Thus the aerosol generation device 20 can supply power to the electrically conductive material of the heater layer 11 in order to heat the layers of aerosol substrate 12 and thereby generate an aerosol.

The sandwich-like arrangement of the adjacent layers of the consumable 10 has the effect that the heater layer 11 is electrically and thermally insulated by the aerosol substrate layers 12. This allows for a simple design of the consumable 10 while reducing a risk of the heater layer 11 damaging the aerosol generation device 20. Additionally, this eliminates the need for a separate electrical insulating layer such as polyimide. By attaching the aerosol substrate to the heater layer, without any intermediate insulating layer, the heating can be made faster and more efficient.

More specifically, in a first example, the consumable is suitable for an aerosol generation device 20 in which the electrical contacts are piercing electrical contacts that form part of piercing elements 23. The piercing elements are adapted to pierce the consumable 10 through one or more of the layers of aerosol substrate 12, and to form an electrical connection between the piercing electrical contact and the heater layer 11.

Referring again to FIG. 2A, in a first embodiment of an aerosol generation device which is compatible with the first example of the consumable, the aerosol generation device 20 comprises a housing 21 comprising a chamber 22 adapted to receive the consumable 10. The chamber 22 comprises an opening through which the consumable can be inserted and removed, and the aerosol generation device 20 further comprises a cover 24 arranged to move between an open position (shown in FIG. 2A) in which the opening is open, and a closed position (shown in FIG. 2B) in which the opening is closed. The cover 24 is attached to the housing 21 by a hinge 25.

More specifically, the chamber 22 is adapted such that, when the consumable is inserted, the consumable is positioned correctly for the electrical contacts to supply power to the heater layer. The chamber 22 may be dimensioned to ensure that the consumable is inserted with the correct orientation for piercing by the piercing elements through the one or more of the layers of aerosol substrate 12 in order to make electrical contact with the heater layer 11. Additionally, the chamber 22 may be dimensioned for the consumable to have a snug fit, or the heater layer of the consumable may be designed to tolerate different positioning of the electrical contacts. For example, the heater layer may be a uniform material such that no specific positioning of the electrical contacts is required to supply power to the heater layer.

The piercing elements 23 are attached to the cover 24. The cover 24 is arranged such that, when a user inserts the consumable 10 into the chamber 22 and moves the cover 24 to the closed position, the piercing elements 23 are pushed into the consumable 10, resulting in a configuration as shown in FIG. 2B. The chamber 22 is bounded when closed as shown in FIG. 2B, and the corresponding bounding is illustrated in FIG. 2A using a dashed line at the opening of the chamber.

The piercing elements 23 are arranged to extend inside the chamber a distance which is sufficient to contact the heater layer or even traverse it. The piercing element may extend in a transverse direction of the chamber along a distance of at least 40%, preferably at least 50%, such as 70% or 80% of the transverse direction. The piercing elements are also preferably distanced one another a sufficient longitudinal distance, preferably at least 50%, more preferably at least 70%, most preferably at least 90% the length of the chamber in the longitudinal direction of the chamber.

The aerosol generation device 20 further comprises a mouthpiece 26 at which the aerosol generation device provides the generated aerosol to the user. The mouthpiece 26 may, for example, be connected to the chamber 22 via a pipe (not shown).

Additionally, the aerosol generation device 20 further comprises a power supply to the electrical contacts and means for the user to control heating by the heater layer.

The first example of the consumable and the first embodiment of the aerosol generation device also have various variants and optional features, non-limiting examples of which are explained in the following.

In the first example of a consumable, the electrically conductive material may comprise a metal, carbon or a mixture of metal and carbon. Additionally, in the first example of a consumable, the heater layer may be flexible or deformable, to assist in manufacturing the consumable and potentially make the consumable easier for a user to handle and insert in an aerosol generation device. These features may, for example, be achieved by using a thin solid conductive layer or a network of conductive fibres. The heater layer may, for example, be formed of one or more of a sintered metal, a wire wool, a mesh, a non-woven material, a film, a tape, or a meandering track. The heater layer may be a conductive layer having a resistance above 10 Ohms, preferably above 20 Ohms, for example of approximately 30 Ohms. Therefore, as opposed to a metal heater, the heater layer requires higher voltage but lower current to heat. The heater may be a carbon tape or film. The heater layer may, for example, comprise Kynol® carbon material.

The heater layer 11 may not form a complete barrier between the layers of aerosol substrate 12, for example in the case where it is formed of a track, and the layers 12 of aerosol substrate may be partially in contact with each other. Additionally, despite the above-mentioned benefit of placing heating part of the heater layer 11 in direct contact with the layers of aerosol substrate 12, the heater layer 11 may internally comprise an insulator.

In the first example of a consumable, the aerosol substrate takes the form of a foam which is extruded into a layer. The foam structure in the foam is not particularly limited and can, for example, comprise trapped air bubbles. It can be provided as an open structure with a large surface area, which enables heat and aerosol to circulate through the foam, particularly during heating, thus providing uniform heating, a good quality aerosol, and extremely efficient extraction of the aerosol.

The foam comprises an inhalable agent which, when heated, generates or releases a component of the aerosol generated by the aerosol generation device. The inhalable agent may, for example, be a tobacco ingredient. Additionally, the foam comprises an aerosol forming agent, a foam forming agent and a foam stabilizing agent. The foam forming agent can generally trap bubbles when the foam is formed, e.g. whipped, and the foam stabilizing agent can reduce and even prevent breakdown of the foam. The inhalable agent may be configured to be released upon heating together with the aerosol forming agent.

The foam forming agent is not particularly restricted. The foam forming agent may, for example, comprise agar, gellan gum, lecithin, esters of fatty acids, and/or mixtures thereof, without being limited thereto. Furthermore, the aerosol forming agent is not particularly limited. The aerosol forming agent may, for example, comprise glycerol, glycol derivatives such as propylene glycol, sebacate esters and/or mixtures thereof, without being limited thereto.

In this embodiment, the inhalable agent is 0.1 wt % to 33 wt % of the foam, and the aerosol forming agent is 10 wt % to 80 wt % of the foam. More preferably, the aerosol forming agent is 40 wt % to 70 wt % of the foam. The aerosol substrate layers may, for example, be reconstituted tobacco sheets. As alternatives to a foam, the aerosol substrate may be extruded from a dough, a slurry or a mousse.

In a specific example, the aerosol substrate may be produced by extruding a mixture comprising approximately 1 wt % to approximately 7 wt % carboxymethylcellulose (CMC), approximately 10 wt % to approximately 35 wt % glycerine, and tobacco power with particle size of approximately 20 μm to 300 μm.

In another specific example, each layer of aerosol substrate has a thickness of 80 μm to 2 mm, and preferably 1.40 mm. The moisture content may be 10 wt % to 15 wt %, and preferably 12.5 wt %. Herein “moisture content” refers only to water, and does not include any humectant which may be present.

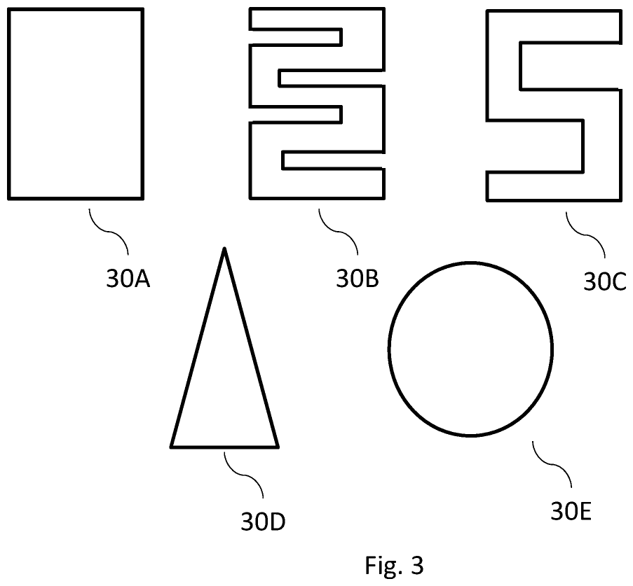

As shown in FIG. 3, the consumable 10 may be formed with a variety of plan-view shapes, by cutting, stamping or punching through a sheet or ribbon comprising the adjacent layers. In other words, the consumable may be shaped with a cross-section that is the same in each layer. For example, the consumable may have a rectangular shape 30A, or more specifically a sim-card shape. The consumable may alternatively have a meandering or serpentine track shape 30B or 30C. Furthermore, the consumable may have a triangular shape 30D or a circular shape 30E. Different shapes may be used to provide different heat profiles across the consumable. The plan-view shape of the consumable 10 may be formed with any suitable dimensions. In one specific example, the consumable 10 is formed with a rectangular shape 30A with length and width dimensions of 18 mm by 12 mm.

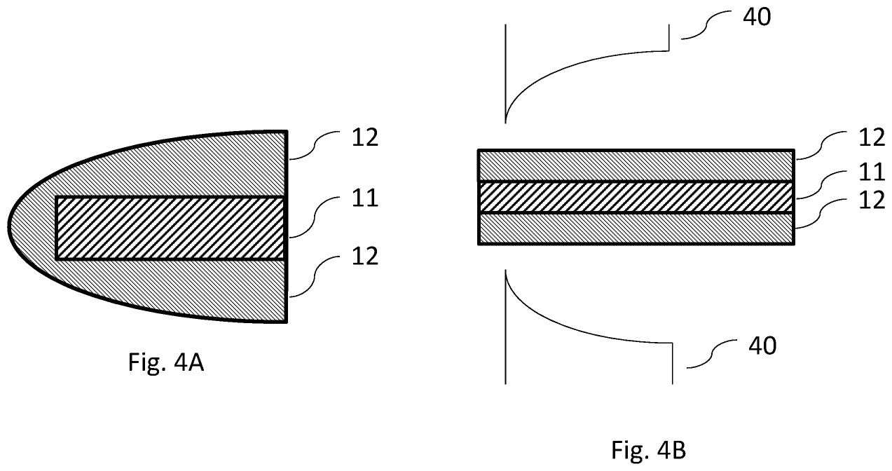

As shown in FIG. 4A, each layer of the consumable 10 need not have the same cross-section. For example, at an edge of the shape, the aerosol substrate layers 12 may extend beyond the heater layer 11, such that the heater layer 11 is enclosed at the edge by the layers of aerosol substrate 12. This has the effect of also insulating the edge of the heater layer 11. This may be a result of the way the consumable shape is cut, stamped or punched. For example, the consumable 10 may be cut from a ribbon using a cutting tool 40 with a curved blade, as shown in FIG. 4B. Furthermore, the heater layer 11 may be enclosed at all of its edges by the layers of aerosol substrate 12.

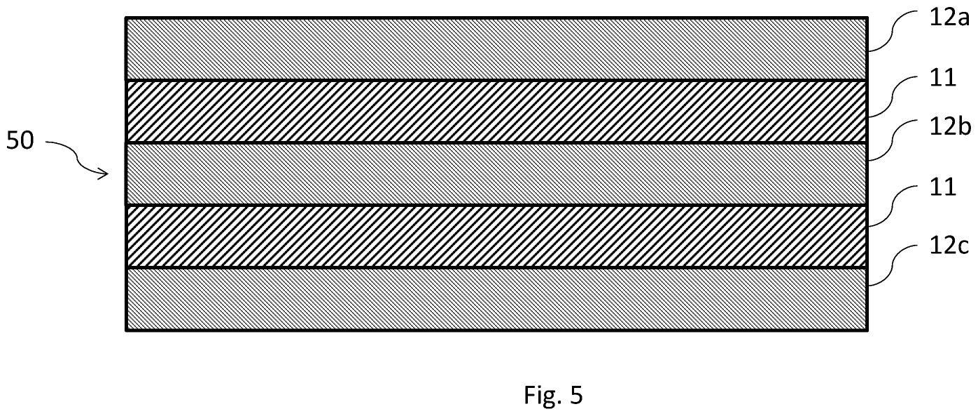

Additionally, as shown in FIG. 5, the consumable 50 may comprise a plurality of heater layers 11. There is a layer of aerosol substrate 12 on each side of each heater layer 11. In such cases, the piercing elements 23 of a corresponding aerosol generation device may be required to pierce multiple heater layers 11, or additional piercing elements may be included to ensure that power is supplied to all of the heater layers 11 of the consumable 50. By increasing the number of heater layers, the contact area between heater layers and aerosol substrate layers is increased. Additionally, the overall resistance of the electrical resistance may be reduced when the consumable receives power.

In FIG. 5, the plurality of adjacent layers of the consumable 50 comprises alternating heater layers 11 and aerosol substrate layers 12. In such embodiments, the thickness of the aerosol substrate layers 12 may vary. For example, the middle aerosol substrate layer 12b shown in FIG. 5 may have double the thickness of the outer aerosol substrate layers 12a, 12c in order to increase the uniformity of heat distribution when the aerosol substrate layers 12a, 12b, 12c are heated by the heater layers 11.

In the first embodiment of an aerosol generation device, there are two piercing elements 23 each with a respective electrical contact. However, there may be only one piercing element with multiple electrical contacts arranged to supply power to the heater layer. For example a single piercing element may extend along the consumable and may have an electrical contact at each end of the piercing element. Alternatively, there may be more than two piercing elements each having zero or more electrical contacts arranged to supply power to the heater layer. Where a piercing element has zero electrical contacts, it simply serves to hold the consumable. Furthermore, each of the piercing elements 23 may be attached to the cover 24 or the housing 21.

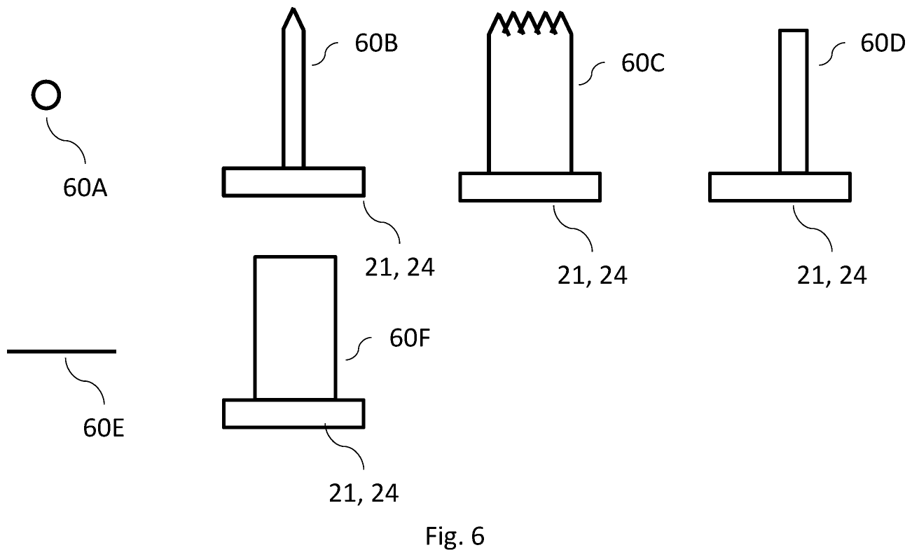

As shown in FIG. 6, the consumable may receive a piercing element 23 with any suitable shape for piercing the materials of the consumable. The piercing elements 23 may, for example, each have a round cross-section 60A or a thin blade cross-section 60E. The piercing elements 23 may each have a needle-type tip 60B, a crown-type tip 60C, a punch-type tip 60D, or a blade-type tip 60F. The piercing elements 23 may be solid or hollow.

In the first embodiment of an aerosol generation device, the cover 24 is attached to the housing 21 by a hinge 25. However, the hinge may instead be replaced with another means for attaching the cover 24 to the housing 21. Furthermore, the cover 24 may be fully separate from the housing 21.

In the first embodiment of an aerosol generation device, the cover 24 is arranged to push the piercing element into the consumable as a user moves the cover to the closed position. However, additionally or alternatively, the aerosol generation device may comprise an actuator arranged to drive the piercing element(s) into the consumable. This may, for example, be an electronically controlled actuator which activates when the cover is in the closed position, either automatically in response to closing of the cover, or based on a button-press by a user.

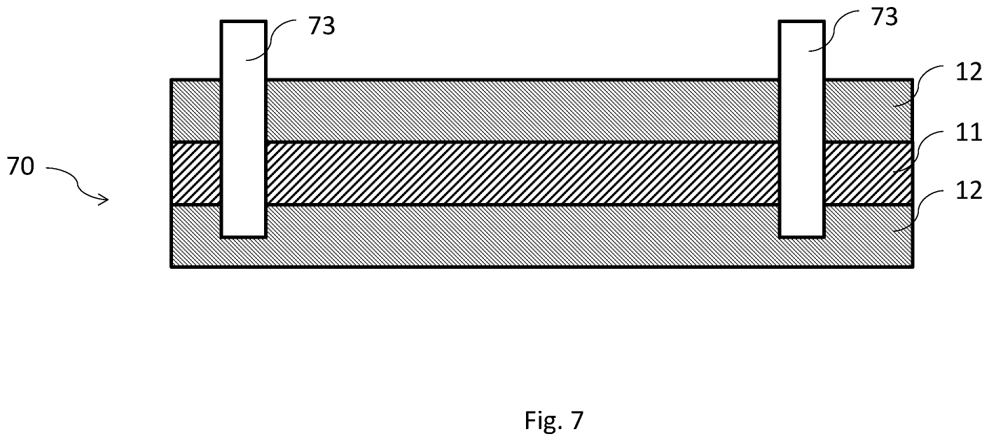

FIG. 7 illustrates a cross-section of a second example of the consumable 70. The second example is the same as the first example except for the following details, and the above described variants and modifications of the first example are also applicable to the second example.

As shown in FIG. 7, the consumable 70 is provided with a plurality of electrical contacts 73 which are connected to the heater layer. These pre-provided contacts eliminate the need for piercing elements in a corresponding aerosol generation device by providing external contacts to supply power to the heater layer 11.

More specifically, the electrical contacts 73 are embedded in respective holes through the plurality of adjacent layers 12, 11, 12 of the consumable. Each hole may instead only extend through the heater layer 11 and one of the aerosol substrate layers 12. These holes correspond to holes which would otherwise be generated by the piercing elements in the first example.

Similarly to the first example, it is also possible to provide a plurality of electrical contacts embedded in a single hole and arranged to supply power to the heater layer. For example, a single long hole may have an electrical contact embedded at each end of the hole.

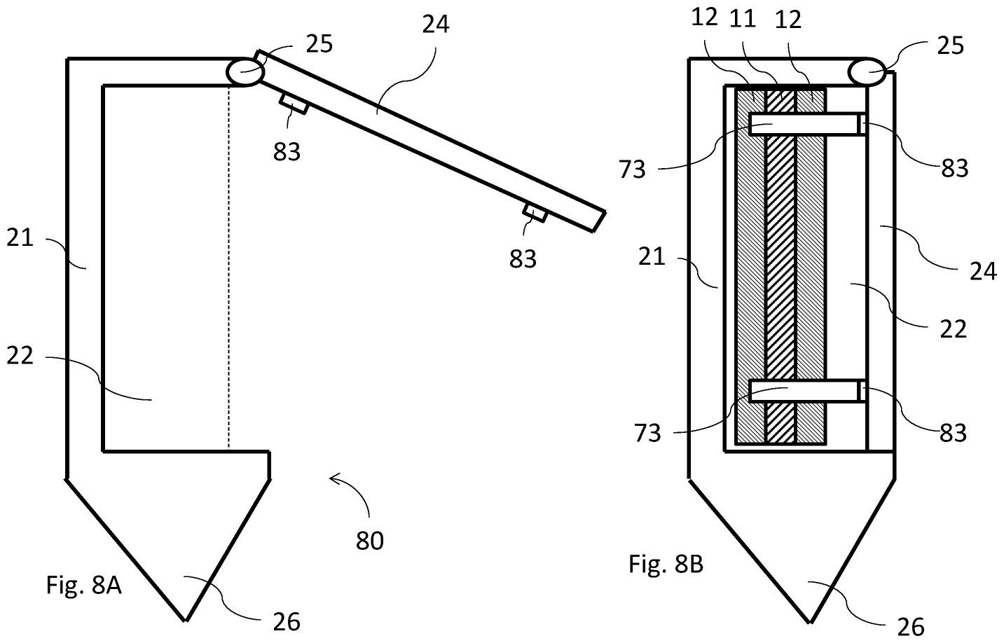

FIGS. 8A and 8B illustrate cross-sections of a second embodiment of an aerosol generation device 80 which is suitable for use with a consumable of the second example. The second embodiment is the same as the first embodiment except for the following details, and the above described variants and modifications of the first embodiment are also applicable to the second embodiment.

As shown in FIG. 8A, the piercing elements 23 of the first embodiment are replaced with shorter electrical contacts 83. Each electric contact 83 is arranged to form an electrical connection with a respective electrical contact 73 of the consumable 70, the electrical contact 73 being connected in the consumable between the heater layer 11 and an outer layer 12 of the plurality of adjacent layers of the consumable.

Combinations and intermediate versions of the first and second examples and embodiments are possible.

For example, the consumable may be provided with holes adapted to receive electrical contacts, as described in the second example, but without actually comprising the electrical contacts. In this case, an aerosol generation device of the first embodiment may be used with the consumable, and a smaller force is required to drive the piercing elements 23 into the pre-arranged holes of the consumable, as compared to driving the piercing elements 23 into a hole-free consumable of the first example.

Additionally, the consumable may be provided with only one electrical contact 73 as described in the second example, and may be used with an aerosol generation device having both a piercing element 23 as described in the first embodiment and a contact 83 as described in the second embodiment. This would improve safety by making it more difficult to use the device with a consumable for which it is not designed, and vice-versa.

Beyond the above disclosure, additional consumables are possible.

For example, in the above description, consumables are used with an aerosol generation device having a chamber 22 in which the aerosol is generated and a mouthpiece 26 from which a user obtains the aerosol. However, the consumable may itself provide a chamber and/or a mouthpiece. For example, a layered sheet, with aerosol substrate layers attached to each side of a heater layer, may be rolled, bobbinized, or sealed to form a hollow tube. In such a case, the inside of the tube may provide the chamber, and an end of the tube may be used as the mouthpiece. Therefore, a corresponding aerosol generation device need only provide a power supply using, for example, one of the above-described types of electrical contacts. In a case where the aerosol generation device has piercing elements, these would also serve the function of holding the consumable in place relative to the device.

The consumables and the devices described above may be distributed separately, or may be supplied together as a system for generating an aerosol.

In some examples, the aerosol generation device of the system may itself be disposable and may have a finite consumable, having the above-described speed and efficiency advantages, located therein. In such examples, a movable cover is unnecessary for the aerosol generation device. If the aerosol generation device has an actuator for a piercing element, the consumable may be arranged in the aerosol generation device such that at least one layer of aerosol substrate is arranged to be pierced by the piercing element.

1. An aerosol generation device for generating an aerosol from a consumable comprising a plurality of adjacent layers including a heater layer comprising electrically conductive material and a layer of aerosol substrate on each side of the heater layer and attached to the electrically conductive material, the device comprising:
a housing comprising a chamber adapted to hold the consumable; and
a plurality of electrical contacts arranged to supply power to the heater layer of the consumable held in the chamber, through one or both outer layers of the plurality of adjacent layers of the consumable.

2. An aerosol generation device according to claim 1, wherein the chamber is adapted such that, when the consumable is inserted into the chamber, the consumable is positioned so that the electrical contacts to supply power to the heater layer.

3. An aerosol generation device according to claim 1, wherein the chamber comprises an opening through which the consumable can be inserted into and removed from the chamber, and the aerosol generation device further comprises a cover arranged to move between an open position in which the opening is open and a closed position in which the opening is closed.

4. An aerosol generation device according to claim 3, wherein the cover is attached to the housing by a hinge.

5. An aerosol generation device according claim 1, further comprising a piercing element including a piercing electrical contact of the plurality of electrical contacts of the aerosol generation device, the piercing element being adapted to pierce the consumable and form an electrical connection between the piercing electrical contact and the heater layer.

6. An aerosol generation device according to claim 5, wherein the piercing element has a needle-type, crown-type, blade-type or punch-type tip.

7. An aerosol generation device according to claim 5, wherein the piercing element includes multiple piercing electrical contacts of the plurality of electrical contacts of the aerosol generation device, the multiple piercing electrical contacts being arranged to form multiple electrical connections with the heater layer.

8. An aerosol generation device according to claim 5,
wherein the chamber comprises an opening through which the consumable can be inserted into and removed from the chamber, and the aerosol generation device further comprises a cover arranged to move between an open position in which the opening is open and a closed position in which the opening is closed, and
wherein the cover is arranged to push the piercing element into the consumable as the cover moves to the closed position.

9. An aerosol generation device according to claim 5, further comprising an actuator arranged to drive the piercing element into the consumable.

10. An aerosol generation device according to claim 1, wherein the chamber has a width dimension orthogonal to a longitudinal direction of the chamber, and wherein the plurality of electrical contacts are arranged to extend within the chamber in a direction transverse to the longitudinal direction of the chamber and to extend at least along 30% of the width dimension of the chamber.

11. An aerosol generation device according to claim 1, wherein the chamber has a longitudinal direction, and wherein the plurality of electrical contacts comprise at least two contacts spaced apart along the longitudinal direction by a distance of at least 50%, of a length of the chamber in the longitudinal direction.

12. An aerosol generation device according to claim 1, wherein an electrical contact of the plurality of electrical contacts of the aerosol generation device is arranged to form an electrical connection with a respective electrical contact of the consumable positioned in the consumable between the heater layer and one of the outer layers of the plurality of adjacent layers.

13. A system for generating an aerosol comprising: an aerosol generation device according to claim 1; and the consumable comprising the plurality of adjacent layers including the heater layer and the layer of aerosol substrate on each side of the heater layer.

14. A system according to claim 13, wherein the aerosol generation device further comprises a piercing element including a piercing electrical contact of the plurality of electrical contacts of the aerosol generation device, the piercing element being adapted to pierce the consumable and form an electrical connection between the piercing electrical contact and the heater layer, and wherein at least one of the layers of aerosol substrate of the consumable is arranged to be pierced by the piercing element of the aerosol generation device.

15. A system according to claim 13, wherein the heater layer comprises electrically conductive material comprising a metal and/or carbon.

16. A system according to claim 15, wherein the heater layer has a resistance above 10 Ohms.

17. A system according to 13, wherein the heater layer is formed of one or more of a sintered metal, a wire wool, a mesh, a film, a tape, a non-woven material and a meandering track.
